(19) United States
(12) Patent Application Publication
(10) Pub. No.: US 2011/0077992 A1
(43) Pub. Date: Mar. 31, 2011

(54) METHODS, SYSTEMS, AND COMPUTER PROGRAM PRODUCTS FOR TELECOMMUNICATIONS PRODUCT AND/OR SERVICE OFFERINGS

(75) Inventor: Stephen Harris, Alpharetta, GA (US)

(73) Assignee: AT&T Intellectual Property I, L.P.

(21) Appl. No.: 12/570,484

(22) Filed: Sep. 30, 2009

(51) Int. Cl. G06Q 10/00; G06Q 20/00; G06Q 50/00

(52) U.S. Cl. 705/8; 705/346; 705/17

(57) ABSTRACT

Some embodiments provide sales management methods, apparatus and computer program products. A customer at a public retail site is identified, along with a reason for a visit of the customer to the public retail site. A customer profile of the customer is identified responsive to the identification of the customer. A telecommunications product and/or service available to the customer is identified based on the customer profile and the identified reason for the visit. A display of information relating to the identified available telecommunications product and/or service is provided at a terminal positioned at the public retail site.

### BACKGROUND OF THE INVENTION

The present application relates generally to managing telecommunications products and/or services and, more particularly, to methods, systems and computer program products for managing telecommunications customer interactions.

Telecommunications products and/or services are commonly sold at distributed public retail sites. For example, wireless and/or wireline products and/or services are often sold in retail stores located in, for example, shopping malls and airports. Such retail stores may also offer self-serve options, such as self-serve kiosks that may be used by customers to pay monthly service charges, purchase minutes for prepaid services or conduct account management activities, such as personal information updates.

Conventionally, a customer entering such a retail store for other than a self-service matter may manually enter his or her name on a sign in sheet and await service from a customer representative. This process may be automated by using an electronic queuing system in which a customer enters his or her identification information at a queuing system terminal or kiosk that provides queue control functions for the sales staff.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Some embodiments provide sales management methods for telecommunications products and/or services. The methods include identifying a customer at a public retail site, identifying a reason for a visit of the customer to the public retail site, identifying a customer profile of the customer responsive to the identification of the customer, identifying a telecommunications product and/or service available to the customer based on the customer profile and the identified reason for the visit and causing display of information relating to the identified available telecommunications product and/or service at a terminal positioned at the public retail site.

In some embodiments, identifying a customer at a public retail site includes accepting a user input of an identification of the customer at a customer kiosk or sales representative terminal positioned at a retail store location. Identifying a reason for a visit of the customer to the public retail site may include accepting a user input of information identifying the reason at the customer kiosk or sales representative terminal.

In some embodiments, identifying a customer profile of the customer responsive to the identification of the customer may include transmitting an identification of the customer and information describing the reason for the visit of the customer to the public retail site from the public retail site to an application server and identifying the customer profile at the application server based on the transmitted identification of the customer. Identifying a telecommunications product and/or service available to the customer based on the customer profile and the identified reason for the visit may include generating the information relating to the identified available telecommunications product and/or service at the application server responsive to the identified customer profile and the transmitted information describing the reason for the visit to the public retail site and transmitting the information relating to the identified available telecommunications product and/or service from the application server to the terminal positioned at the public retail site.

In some embodiments, identifying a customer at a public retail site terminal at a public retail site may include accepting user input of an identification of the customer at a self-service kiosk. Causing display of information relating to the identified available telecommunications product and/or service at terminal positioned at the public retail site may include causing display of the information relating to the identified available telecommunications product and/or service at the self-service kiosk. Causing display of the information relating to the identified available telecommunications product and/or service at the self-service kiosk may include causing display of the information relating to the identified available telecommunications product and/or service at the self-service kiosk responsive to completion of a payment transaction at the self-service kiosk.

In some embodiments, identifying a customer at a public retail site includes accepting user input of an identification of the customer at a customer queuing system input terminal positioned at the public retail site, and causing display of information relating to the identified available telecommunications product and/or service at terminal positioned at the public retail site may include causing display of the information relating to the identified available telecommunications product and/or service at a sales representative terminal positioned at the public retail site. Causing display of the information relating to the identified available telecommunications product and/or service at a sales representative terminal positioned at the public retail site may include causing display of the information relating to the identified available telecommunications product and/or service responsive to a queue status of the customer.

The methods may further include accepting an indication of customer interest in the identified available telecommunications product and/or service at the terminal positioned at the public retail site.

According to further embodiments of the present invention, a sales management system includes an application server computer configured to be coupled to a client computer positioned at a public retail site, to identify a customer at the public retail site via the client computer, to identify a reason for a visit of the customer to the public retail site via the client computer, to identify a customer profile of the customer responsive to the identification of the customer, to identify a telecommunications product and/or service available to the customer based on the customer profile and the identified reason for the visit and to cause display of information relating to the identified available telecommunications product and/or service at a terminal positioned at the public retail site. The client computer may include, for example, a customer kiosk and/or a sales representative terminal. For example, in some embodiments, the client computer may include a self-service kiosk, and the application server compute may be configured to cause display of the information relating to the identified available telecommunications product and/or service at the self-service kiosk. In further embodiments, the client computer may include a customer queuing system input terminal positioned at the public retail site, and the application server computer may be configured to cause display of the information relating to the identified available telecommunications product and/or service at a sales representative terminal positioned at the public retail site.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram illustrating systems and methods for managing customer sales interactions in accordance with some embodiments;

FIG. 2 illustrates a screen shot for a sales representative terminal in accordance with some embodiments;

FIG. 3 is a block diagram illustrating systems and methods for managing customer sales interactions in accordance with further embodiments;

FIG. 4 illustrates a screen shot for a sales representative terminal in accordance with some embodiments;

FIG. 5 is a block diagram illustrating systems and methods for managing customer sales interactions in accordance with further embodiments;

FIG. 6 illustrates a screen shot for a self-service kiosk in accordance with some embodiments;

FIG. 7 is a flowchart that illustrates operations methods, systems, and computer program products in accordance with some embodiments.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations discussed herein may be written in a high-level programming language, such as Java, C, and/or C++, for development convenience. In addition, computer program code for carrying out operations according to some embodiments may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Embodiments are described hereinafter with reference to flowchart and/or block diagram illustrations of methods, systems, client devices, and/or computer program products in accordance with some embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

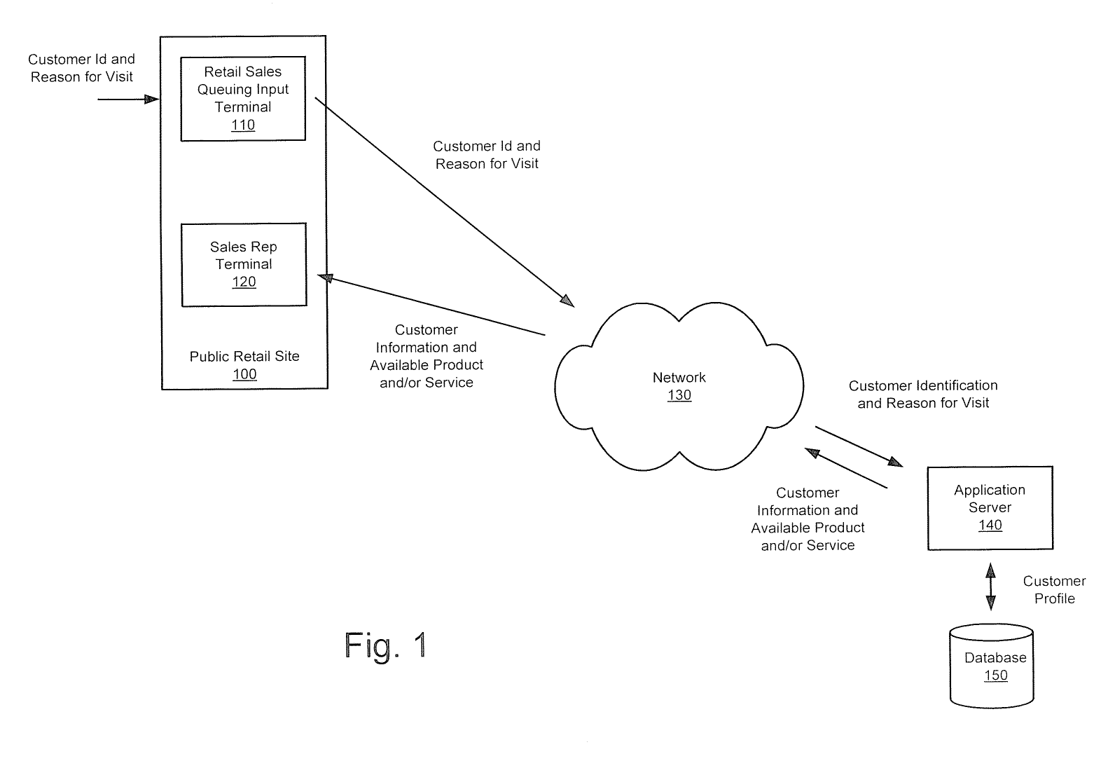

FIG. 1 illustrates a sales management system according to some embodiments. The system includes a retail sales queuing system input terminal 110 positioned at a public retail site 100, such as a retail store that sells telecommunications products and/or services, such as wireline or wireless services and associated user equipment. The queuing system input terminal 110 is configured to accept input of a customer identification (e.g., a telephone number) and a reason for the customer's visit to the public retail site 100. This information is conveyed to an application server 140 over a network 130.

Based on the communicated customer identification, the application server 140 identifies an appropriate customer profile for the customer, for example, by searching in a database 150. It will be appreciated that, in general, the application server 140 and/or database 150 may be positioned at a single location and/or may be distributed over multiple sites. Based on the customer profile and the reason for the customer visit, the application server 140 may generate customer information and information regarding a product and/or service available to the customer and transmit this information to a sales representative terminal 120 positioned at the public retail site 100. The sales representative terminal 120 may be, for example, a desktop or laptop computer, a point of sale (e.g., cash register) terminal or a handheld device, such as a tablet computer or PDA.

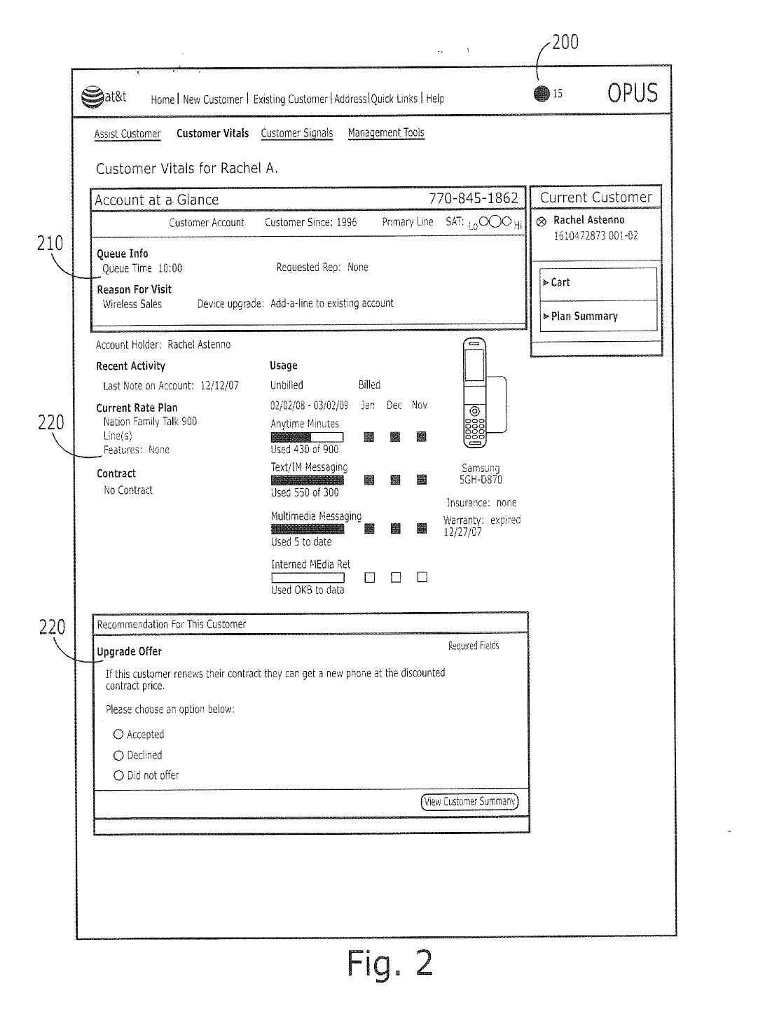

FIG. 2 illustrates an example of a window 200 that may be displayed on the sales representative terminal 120. The window 200 may include a first field 210 displaying information about the customer's queuing information and reason for visiting the public retail site 100. A second field 220 may be used to display information about the customer's account, such as current lines of service, rate plans, usage, equipment and the like. A third field 230 may be used to display information relating to a product and/or service available to the customer. The sales representative may use this information in managing the sales interaction with the customer, such that the customer experiences a more personalized interaction.

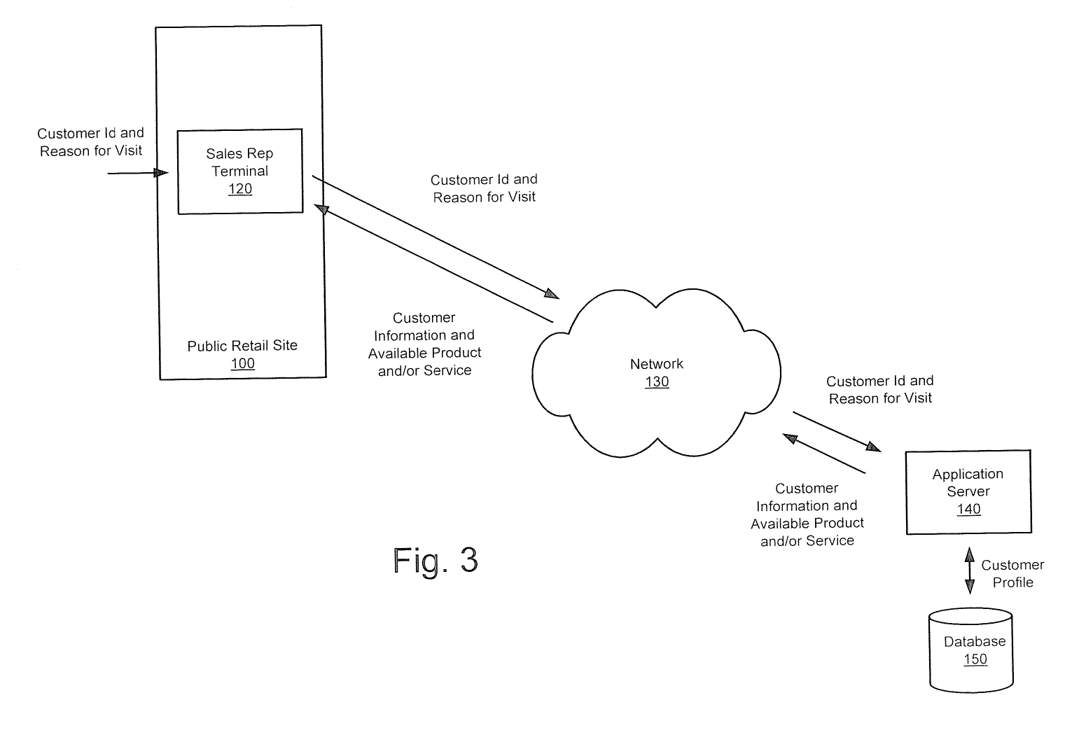

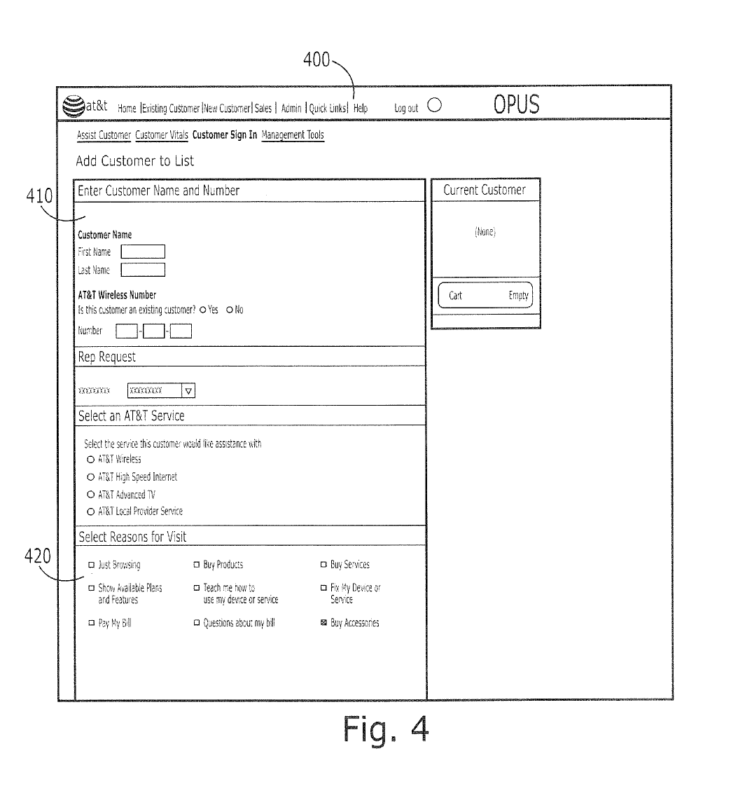

In embodiments of the present invention illustrated in FIG. 3, similar functionality may be provided using only a sales representative terminal 120. In particular, instead of a customer registering with a queuing kiosk or similar terminal, the sales representative may personally greet the customer and enter customer identification and the reason for the customer's visit into the sale representative's terminal 120. This information may be conveyed by to an application server along lines discussed above, with the application server 140 responsively returning customer information and information relating to an available product and/or service for that customer back to the sales representative's terminal 120. FIG. 4 illustrates a window 400 that may be used for customer input under such an arrangement, including a field 410 for entering customer identification information and a field 420 for entering a reason for the customer's visit.

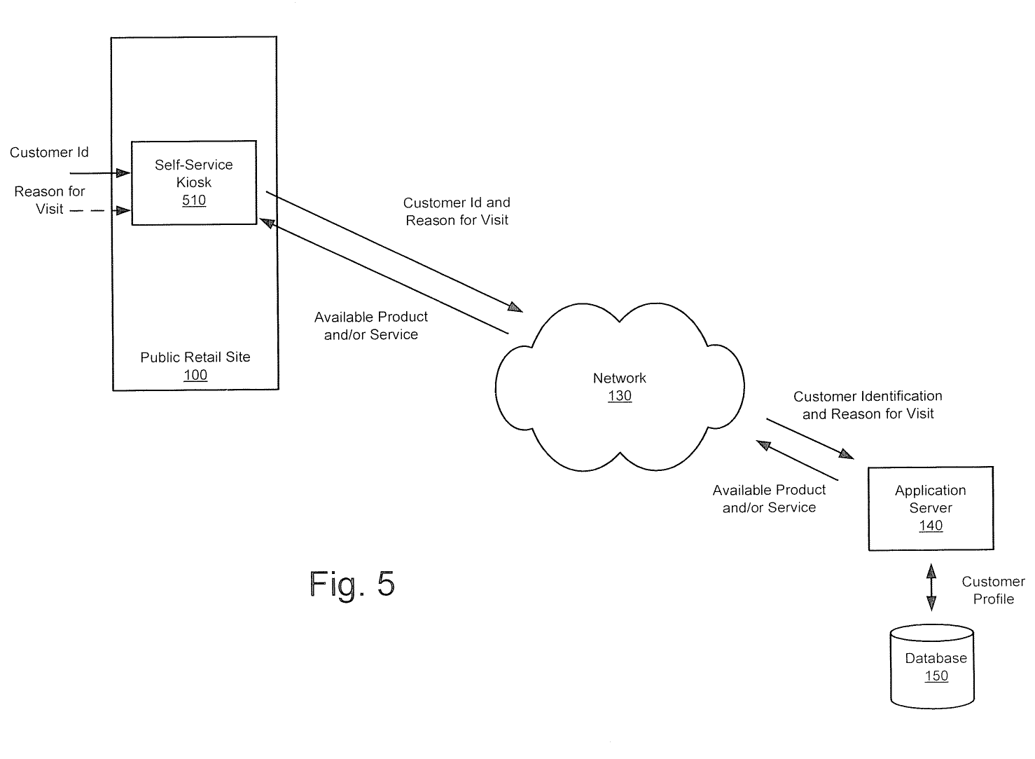

FIG. 5 illustrates a telecommunications sales management system according to further embodiments of the present invention. In these embodiments, customer identification is entered into a self-service kiosk 510 positioned at a public retail site 100. The kiosk 510 may also accept entry of a reason for the customer's visit to the site 100 and/or the reason may be inferred from the nature of the transaction(s) conducted by the customer using the kiosk 510. Along the lines discussed above, this information may be forwarded to an application server 140 over a network 130, with the application server 140 responsively returning customer information and information relating to an available product and/or service for that customer back to the kiosk 510 for display to the customer. In some embodiments, for example, the information relating to available products and/or services may be displayed at the kiosk 510 upon completion of a transaction, such as a bill payment.

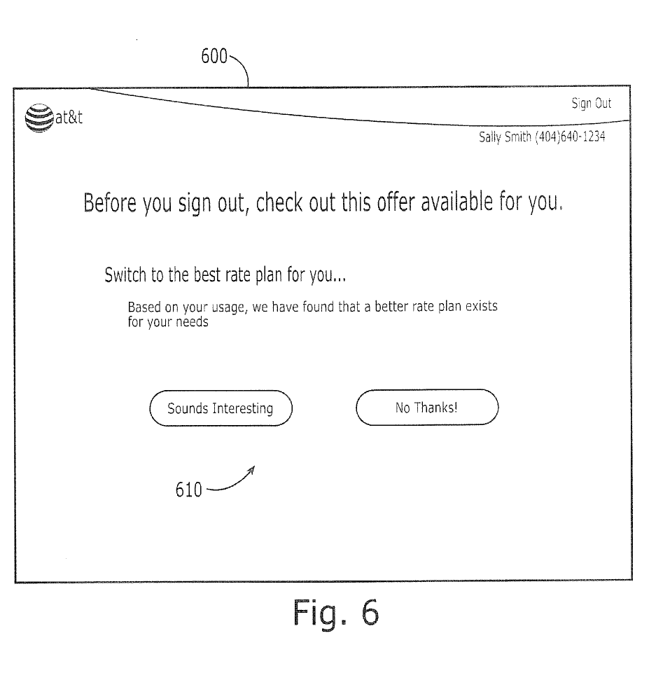

FIG. 6 illustrates an exemplary interface 600 which may be provided at the kiosk 510, which informs the customer using the kiosk of a product and/or service the customer may select and includes buttons 610 which may be selected by the customer to show interest in the product and/or service offering. If the customer activates a button indicating interest, the customer interest may be communicated back to the application server 140, which may support further operations to provide the requested product and/or service. If the customer declines the product and/or service offer, this may also be communicated to the application server 140, which may prevent further offering of the product and/or service to this particular customer for a predetermined amount of time following the customer's declining of the product and/or service offer.

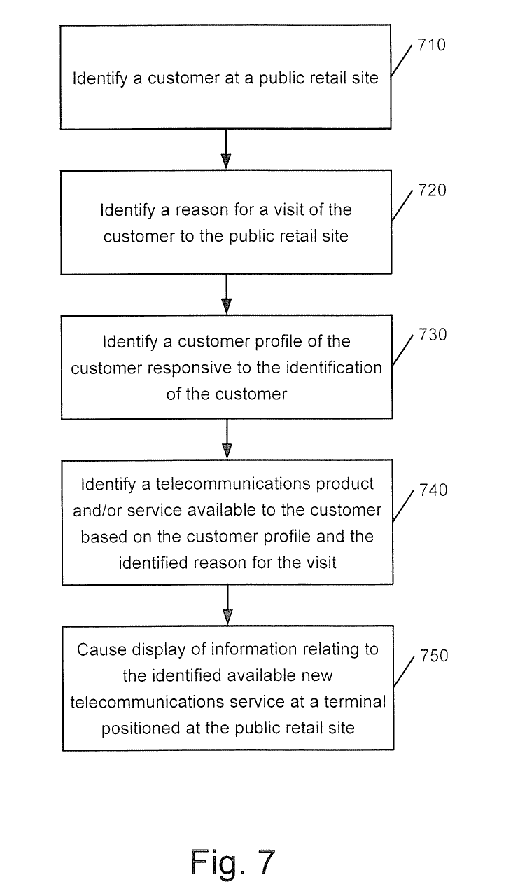

FIG. 7 illustrates exemplary telecommunications sales management operations according to some embodiments. A customer at a public retail site is identified (block 710). A reason for the customer's visit to the public retail site is also identified (block 720). Responsive to this information, a customer profile for the customer is identified (block 730). Based on the identified profile and the reason for the customer's visit, a telecommunications product and/or service that is available for the customer is identified (block 740). A display of information relating to the available product and/or service is provided at a terminal positioned at the public retail site (block 750).

It will be appreciated that the operations illustrated in FIG. 7 may, for example, be implemented in apparatus along the lines illustrated in FIGS. 1, 3 and 5, or in other arrangements of computer apparatus. For example, the operations of FIG. 7 may be implemented in an application server alone, e.g., based on information provided from terminals, or may be distributed among client and server devices.

The flowchart of FIG. 7 illustrates architecture, functionality, and operations of embodiments of methods, systems, and/or computer program products. In this regard, each block represents a module, segment, or portion of code, which comprises one or more executable instructions for implementing the specified logical function(s). It should also be noted that in other implementations, the function(s) noted in the blocks may occur out of the order noted in FIG. 7. For example, two blocks shown in succession may, in fact, be executed substantially concurrently or the blocks may sometimes be executed in the reverse order, depending on the functionality involved.

Many variations and modifications can be made to the embodiments without substantially departing from the principles of the present invention. All such variations and modifications are intended to be included herein within the scope of the present invention, as set forth in the following claims.

That which is claimed:

1. A sales management method comprising the following acts performed by at least one processor:
identifying a customer at a public retail site;
identifying a reason for a visit of the customer to the public retail site;
identifying a customer profile of the customer responsive to the identification of the customer;
identifying a telecommunications product and/or service available to the customer based on the customer profile and the identified reason for the visit; and
causing display of information relating to the identified available telecommunications product and/or service at a terminal positioned at the public retail site.

2. The method of claim 1, wherein identifying a customer at a public retail site comprises accepting a user input of an identification of the customer at a customer kiosk or sales representative terminal positioned at a retail store location.

3. The method of claim 2, wherein identifying a reason for a visit of the customer to the public retail site comprises accepting a user input of information identifying the reason at the customer kiosk or sales representative terminal.

4. The method of claim 1:
wherein identifying a customer profile of the customer responsive to the identification of the customer comprises:
transmitting an identification of the customer and information describing the reason for the visit of the customer to the public retail site from the public retail site to an application server; and
identifying the customer profile at the application server based on the transmitted identification of the customer;
wherein identifying a telecommunications product and/or service available to the customer based on the customer profile and the identified reason for the visit comprises:
generating the information relating to the identified available telecommunications product and/or service at the application server responsive to the identified customer profile and the transmitted information describing the reason for the visit to the public retail site; and
transmitting the information relating to the identified available telecommunications product and/or service from the application server to the terminal positioned at the public retail site.

5. The method of claim 1:
wherein identifying a customer at a public retail site terminal at a public retail site comprises accepting user input of an identification of the customer at a self-service kiosk; and
wherein causing display of information relating to the identified available telecommunications product and/or service at terminal positioned at the public retail site comprises causing display of the information relating to the identified available telecommunications product and/or service at the self-service kiosk.

6. The method of claim 5, wherein causing display of the information relating to the identified available telecommunications product and/or service at the self-service kiosk comprises causing display of the information relating to the identified available telecommunications product and/or service at the self-service kiosk responsive to completion of a payment transaction at the self-service kiosk.

7. The method of claim 1:
wherein identifying a customer at a public retail site comprises accepting user input of an identification of the customer at a customer queuing system input terminal positioned at the public retail site; and
wherein causing display of information relating to the identified available telecommunications product and/or service at terminal positioned at the public retail site comprises causing display of the information relating to the identified available telecommunications product and/or service at a sales representative terminal positioned at the public retail site.

8. The method of claim 7, wherein causing display of the information relating to the identified available telecommunications product and/or service at a sales representative terminal positioned at the public retail site comprises causing display of the information relating to the identified available telecommunications product and/or service responsive to a queue status of the customer.

9. The method of claim 1, further comprising accepting an indication of customer interest in the identified available telecommunications product and/or service at the terminal positioned at the public retail site.

10. The method claim 1, wherein at least some of identifying a customer at a public retail site, identifying a reason for a visit of the customer to the public retail site, identifying a customer profile of the customer responsive to the identification of the customer, identifying a telecommunications product and/or service available to the customer based on the customer profile and the identified reason for the visit and causing display of information relating to the identified available telecommunications product and/or service at a terminal positioned at the public retail site are performed at an application server connected to a terminal positioned at the public retail site.

11. An apparatus comprising at least one computer configured to perform the method of claim 1.

12. A computer-readable medium having computer code configured to perform the method of claim 1 embodied therein.

13. A sales management system comprising:
an application server computer configured to be coupled to a client computer positioned at a public retail site, to identify a customer at the public retail site via the client computer, to identify a reason for a visit of the customer to the public retail site via the client computer, to identify a customer profile of the customer responsive to the identification of the customer, to identify a telecommunications product and/or service available to the customer based on the customer profile and the identified reason for the visit and to cause display of information relating to the identified available telecommunications product and/or service at a terminal positioned at the public retail site.

14. The system of claim 13, wherein the client computer comprises a customer kiosk and/or a sales representative terminal.

15. The system of claim 13, wherein the client computer comprises a self-service kiosk and wherein the application server computer is configured to cause display of the information relating to the identified available telecommunications product and/or service at the self-service kiosk.

16. The system of claim 15, wherein the application server computer is configured to cause display of the information relating to the identified available telecommunications product and/or service at the self-service kiosk responsive to completion of a payment transaction at the self-service kiosk.

17. The system of claim 13, wherein the client computer comprises a customer queuing system input terminal positioned at the public retail site and wherein the application server computer is configured to cause display of the information relating to the identified available telecommunications product and/or service at a sales representative terminal positioned at the public retail site.

18. The system of claim 17, wherein the application server computer is configured to cause display of the information relating to the identified available telecommunications product and/or service responsive to a queue status of the customer.

19. The system of claim 13, further comprising the client computer.

20. The system of claim 19, wherein the client computer comprises a sales representative terminal, a self-service kiosk and/or a queuing system input terminal.
